(19) United States
(12) Patent Application Publication
(10) Pub. No.: US 2017/0219078 A1
(43) Pub. Date: Aug. 3, 2017

(54) INTEGRATED ELECTRONIC DRIVE UNIT

(71) Applicant: Eaton Corporation, Cleveland, OH (US)

(72) Inventors: Hongbin Wang, Novi, MI (US); Sean Robert Brown, Southfield, MI (US); Richard Kukucka, Ann Arbor, MI (US); Andrew Nathan Edler, Homer, MI (US); Gregory L. Heatwole, Marshall, MI (US)

(73) Assignee: Eaton Corporation, Cleveland, OH (US)

(21) Appl. No.: 15/486,813

(22) Filed: Apr. 13, 2017

Related U.S. Application Data
(63) Continuation of application No. PCT/US2015/055506, filed on Oct. 14, 2015.
(60) Provisional application No. 62/064,005, filed on Oct. 15, 2014.

(51) Int. Cl. F16H 48/36; F16H 48/22; F16H 48/08; B60K 17/16; B60K 17/30

(52) U.S. Cl. CPC F16H 48/36; B60K 17/165; B60K 17/30; F16H 48/08; F16H 48/22; F16H 2048/364; F16D 13/52

(57) ABSTRACT

An integrated electronic drive unit constructed in accordance to one example of the present disclosure includes a differential, a first axle, a second axle and a secondary power system. The differential includes a ring gear fixed for concurrent rotation with a differential case. The differential has a plurality of pinion gears rotatably mounted to the differential case and meshed with first and second side gears. The first axle is coupled to the first side gear. The second axle is coupled to the second side gear. The secondary power system is selectively engageable to at least one of the first and second axles. The integrated electronic drive unit is operable in an open differential mode, a braking mode, an electric vehicle start mode and a torque vectoring mode.

### CROSS-REFERENCE TO RELATED APPLICATIONS

This application is a continuation of International Application No. PCT/US2015/055506 filed on Oct. 14, 2015, which claims the benefit of U.S. Patent Application No. 62/064,005 filed on Oct. 15, 2014. The disclosure of the above application is incorporated herein by reference.

### FIELD

The present disclosure relates generally to differential assemblies and, more particularly, to an electronic limited slip differential.

### BACKGROUND

Differentials are provided on vehicles to permit an outer drive wheel to rotate faster than an inner drive wheel during cornering as both drive wheels continue to receive power from the engine. While differentials are useful in cornering, they can allow vehicles to lose traction, for example, in snow or mud or other slick mediums. If either of the drive wheels loses traction, it will spin at a high rate of speed and the other wheel may not spin at all. To overcome this situation, limited-slip differentials were developed to shift power from the drive wheel that has lost traction and is spinning, to the drive wheel that is not spinning. Typically, a clutch pack can be disposed between a side gear of the differential and an adjacent surface of a gear case of the differential. The clutch pack is operable to limit relative rotation between the gear case and the side gear. Further, it is often desirable to apply torque vectoring wherein the power directed to the drive wheels is varied. The management of torque to the drive wheels of a vehicle is further complicated in hybrid vehicles wherein power is alternatively derived from an internal combustion engine and from a battery pack. An integrated final drive unit that can provide normal open differential function, electronically controlled limited slip, locking, torque vectoring, regenerative braking, and pure electric drive would represent a significant improvement of the art.

The background description provided herein is for the purpose of generally presenting the context of the disclosure. Work of the presently named Inventors, to the extent it is described in this background section, as well as aspects of the description that may not otherwise qualify as prior art at the time of filing, are neither expressly nor impliedly admitted as prior art against the present disclosure.

### SUMMARY

An integrated electronic drive unit constructed in accordance to one example of the present disclosure includes a differential, a first axle, a second axle and a secondary power system. The differential includes a ring gear fixed for concurrent rotation with a differential case. The differential has a plurality of pinion gears rotatably mounted to the differential case and meshed with first and second side gears. The first axle is coupled to the first side gear. The second axle is coupled to the second side gear. The secondary power system is selectively engageable to at least one of the first and second axles. The integrated electronic drive unit is operable in an open differential mode, a braking mode, an electric vehicle start mode and a torque vectoring mode. In the braking mode, vehicle power is directed toward the secondary power system. In the electric vehicle start mode, vehicle power is directed through the differential to the first and second axles and the secondary power system is also directed to one of the first and second axles.

According to additional features the integrated electronic drive unit includes a planetary gear set having a sun gear, a first and second planet gears, and a planetary ring gear, wherein the planetary gear set couples the differential and the secondary power system. The sun gear can encircle the first axle. The sun gear can include a sleeve portion that extends away from the differential. The differential case can be a carrier of the first and second planet gears. The planetary ring gear is meshed with at least one of the first and second planet gears.

According to other features the integrated electronic drive unit includes a dual-directional clutch having a first clutch pack positioned to selectively prevent rotation of the sun gear. The dual-directional clutch further includes a second clutch pack positioned between the sleeve portion of the sun gear and a clutch basket. The clutch basket can be fixed for rotation with the first axle. When the second clutch pack is compressed, the sun gear is locked to the first axle for concurrent rotation.

According to still additional features, the integrated electronic drive unit can further include an actuator comprising a lever arm, a first thrust plate, a second thrust plate and a ball screw configured to move the lever arm in one of a first direction and a second direction. The first clutch pack is compressed upon movement in the first direction. The second clutch pack is compressed upon movement in the second direction. The lever arm can be pivotally moveable. The secondary power system comprises a battery and a motor. In the torque vectoring mode, the integrated electronic drive unit generates drag on one wheel through one of the first and second axles and extracts energy to store in the battery.

An integrated electronic drive unit constructed in accordance to additional features includes a differential, a first axle, a second axle, and a secondary power system. The differential has a plurality of pinion gears rotatably mounted to the differential case and meshed with first and second side gears. The first axle is associated with a first wheel and is coupled to the first side gear. The second axle is associated with a second wheel and is coupled to the second side gear. The secondary power system has a battery and an electric motor. The electric motor is selectively engageable to at least one of the first and second axles. The integrated electronic drive unit is operable in an open differential mode, a braking mode, and an electronic vehicle start mode. In the open differential mode, vehicle power is directed through the differential and the first and second axles. In the braking mode, vehicle power is directed toward the electric motor. In the electric vehicle start mode, total vehicle power is directed to the first and second axles from both of the differential and the electric motor.

According to other features, the integrated electronic drive unit is further operable in a torque vectoring mode. In the torque vectoring mode, the integrated electronic drive unit generates drag on one of the first and second wheels through one of the first and second axles and extracts energy to store in the battery. The integrated electronic drive unit can further comprise a planetary gear set having a sun gear, a first and a second planet gears, and a planetary ring gear. The planetary gear set couples the differential and the electric motor. The sun gear can encircle the first axle and includes a sleeve portion that extends away from the differential.

According to additional features, the differential case is a carrier of the first and second planet gears. The planetary ring gear is meshed with at least one of the first and second planet gears. A dual-directional clutch includes a first clutch pack positioned to selectively prevent rotation of the sun gear. A second clutch pack is positioned between the sleeve portion of the sun gear and a clutch basket. The clutch basket is fixed for rotation with the first axle. When the second clutch pack is compressed, the sun gear is locked to the first axle for concurrent rotation. The integrated electronic drive unit can further include an actuator comprising a lever arm, a first thrust plate, a second thrust plate and a ball screw configured to move the lever arm in one of a first direction and a second direction.

### BRIEF DESCRIPTION OF THE DRAWINGS

The present disclosure will become more fully understood from the detailed description and the accompanying drawings, wherein:

FIG. 1A is a schematic of an integrated electronic drive unit constructed in accordance to one example of the present disclosure, wherein the integrated electronic drive unit is operating in an open differential mode;

FIG. 1B is a schematic of driven wheels when the integrated electronic drive unit is operating in the open differential mode;

FIG. 2A is a schematic of the integrated electronic drive unit shown in FIG. 1A, wherein the integrated electronic drive unit is operating in a braking mode;

FIG. 2B is a schematic of driven wheels when the integrated electronic drive unit is operating in the braking mode;

FIG. 3A is a schematic of the integrated electronic drive unit shown in FIGS. 1A and 2A, wherein the integrated electronic drive unit is operating in an electric vehicle start mode;

FIG. 3B is a schematic of driven wheels when the integrated electronic drive unit is operating in the electric vehicle start mode;

FIG. 4A is a schematic of the integrated electronic drive unit shown in FIGS. 1A, 2A and 3A, wherein the integrated electronic drive unit is operating in a torque vectoring, left-turn mode;

FIG. 4B is a schematic of driven wheels when the integrated electronic drive unit is operating in the torque vectoring, left-turn mode;

FIG. 5A is a schematic of the integrated electronic drive unit shown in FIGS. 1A, 2A, 3A, and 4A, wherein the integrated electronic drive unit is operating in a torque vectoring, right-turn mode; and

FIG. 5B is a schematic of driven wheels when the integrated electronic drive unit is operating in the torque vectoring, right-turn mode.

### DETAILED DESCRIPTION

An integrated electronic drive unit is disclosed that can provide a full range of active torque management functions. The integrated electronic drive unit can operate in normal, open differential mode, an electronically-controlled limited-slip mode (eLSD), and a torque vectoring mode. The integrated electronic drive unit can also facilitate regenerative braking and a pure electric drive start. The integrated electronic drive unit can produce a seamless transition between normal drive, eLSD, and torque vectoring. Examples of the integrated electronic drive unit can define a bolt-on modular design, with minimum impact to original equipment manufacturers.

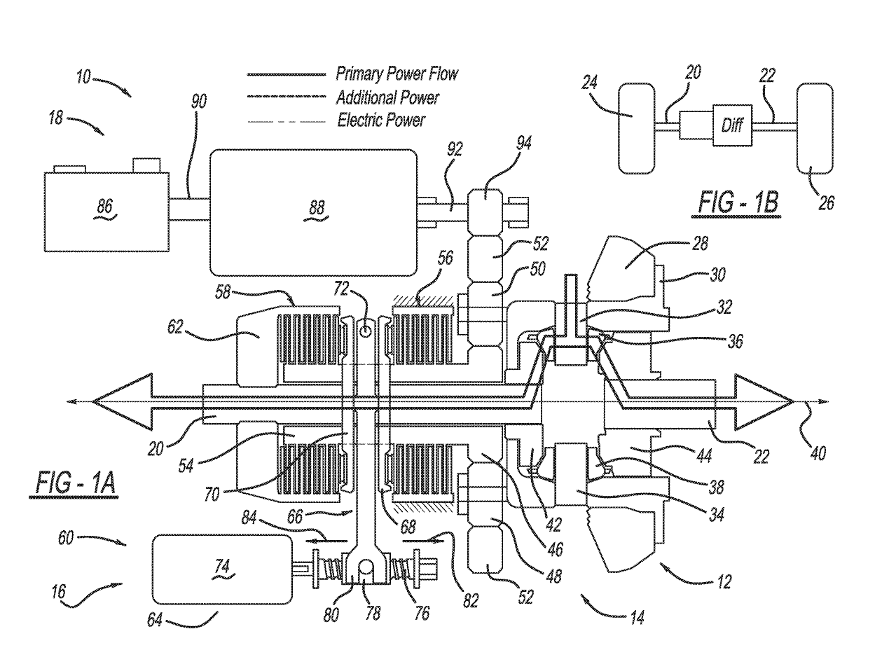

Referring now to FIG. 1A, an integrated electronic drive unit 10 can include a differential 12, a gear train such as a planetary gear set 14, a dual-directional clutch 16, and a secondary power system 18. The integrated electronic drive unit 10 can transmit rotary power to axles 20 and 22. As shown in FIG. 1B, the axles 20, 22 can drive wheels 24, 26.

The differential 12 can include a ring gear 28, a case 30, one or more pins such as pins 32 and 34, a plurality of pinion gears such as pinion gears 36, 38. The ring gear 28 can be driven in rotation about an axis 40 by a vehicle power source, such as by an engine and a drive shaft (not shown). The ring gear 28 and the case 30 can be fixed for rotation together. The pins 32, 34 can be mounted in the case 30 and rotate with the case 30 and the ring gear 28 about the axis 40. The pinion gears 36, 38 can be respectively mounted on the pins 32, 34 for rotation about the respective pins 32, 34. The pinion gears 36, 38 can mesh with side gears 42 and 44. The side gear 42 can be fixed for rotation with the axle 20 and the side gear 44 can be fixed for rotation with the axle 22.

The planetary gear set 14 can include a sun gear 46, planet gears such as planet gears 48 and 50, and a ring gear 52. The sun gear 46 can encircle the axle 20. The sun gear 46 can include a sleeve portion 54 extending away from the differential 12. The case 30 can be a carrier of the planet gears 48 and 50. The ring gear 52 can include internally-directed teeth meshing with the planet gears 48, 50 and externally-directed teeth. While shown and described as a planetary gear set, other gear train configurations may be used to couple the differential 12 and the secondary power system 18.

The dual-directional clutch 16 can include a first clutch pack 56, a second clutch pack 58, and an actuator 60. The first clutch pack 56 can be positioned between the sleeve portion 54 of the sun gear 46 and ground. When the first clutch pack 56 is compressed, the sun gear 46 can be locked, prevented from rotating. The second clutch pack 58 can be positioned between the sleeve portion 54 of the sun gear 46 and a clutch basket 62. The clutch basket 62 can be fixed for rotation with the axle 20. When the second clutch pack 58 is compressed, the sun gear 46 can be locked to axle 20 for concurrent rotation.

The actuator 60 can include a ball screw assembly 64, a lever arm 66, a first thrust plate 68, and a second thrust plate 70. The ball screw assembly 64 can be operable to pivot the lever arm 66 about a pivot axis 72 in first and second opposite angular directions. The ball screw assembly 64 can include a motor 74, a shaft 76, and a nut 78. The motor 74 can rotate the shaft 76 in first and second opposite directions of rotation. The motor 74 can include an internal speed reduction gear set and one or more speed sensors, current sensors or both. The nut 78 can move in a first rectilinear direction in response to rotation of the shaft 76 in the first rotational direction. The nut 78 can move in a second rectilinear direction, opposite to the first rectilinear direction, in response to rotation of the shaft 76 in the second rotational direction. A distal end 80 of the lever arm 66 can form a yoke partially encircling one of the shaft 76 the nut 78.

In operation, the motor 74 can rotate the shaft 76 in the first rotational direction. In response, the nut 78 can move in the rectilinear direction referenced at 82. It is noted that the distance travelled by the nut 78 can be small. The distal end 80 of the lever arm 66 can thereby be urged to pivot about the pivot axis 72, causing the application of force to the first thrust plate 68. Further, the force can be transmitted by the first thrust plate 68 to the clutch pack 56, locking the sleeve portion 54 of the sun gear 46.

In operation, the motor 74 can also rotate the shaft 76 in the second rotational direction. In response, the nut 78 can move in the rectilinear direction referenced at 84. It is noted that the distance travelled by the nut 78 can be small. The distal end 80 of the lever arm 66 can thereby be urged to pivot about the pivot axis 72, causing the application of force to the second thrust plate 70. Further, the force can be transmitted by the second thrust plate 70 to the clutch pack 58, coupling the sleeve portion 54 of the sun gear 46 to the axle 20 for concurrent rotation.

It is noted that other forms of actuators that provide bi-directional actuation can be applied in other examples of the present disclosure. It is also noted that linear actuators other than rotation motors and force multiplication mechanisms other than ballscrew assemblies can be included in other examples of the present disclosure. For example, one or more fluid cylinders could be applied to move the distal end 80 of the lever arm 66.

The secondary power system 18 can be an electrical power system and can include a battery 86 and an electric motor 88. The electrical connection between the battery 86 and the motor 88 is referenced at 90. A motor shaft 92 can extend from the motor 88. A gear 94 can be fixed on the motor shaft 92. The gear 94 can be meshed with the externally-directed teeth of the ring gear 52. Alternative forms of a secondary power system can be applied in alternative examples of the present disclosure, such as a hydraulic system with a hydraulic motor and a hydraulic accumulator. An ultra-capacitor can be utilized as an energy storage device in alternative examples of the present disclosure. The electric motor 88 can further incorporate a mechanical braking device so that the electric motor 88 can operate as a motor, a generator, electric braking or mechanical braking during normal driving for maximum efficiency.

FIG. 1A shows the integrated electronic drive unit 10 operating in an open differential mode. Power from the vehicle power source, or primary power, is directed through the differential 12 and the axles 20, 22 to the wheels 24, 26. The planet gears 48, 50 can orbit about the sun gear 46 and rotate about respective central axes. Any movement of the sun gear 46 and the ring gear 52 is lost motion. Both clutch packs 56 and 58 can be uncompressed.

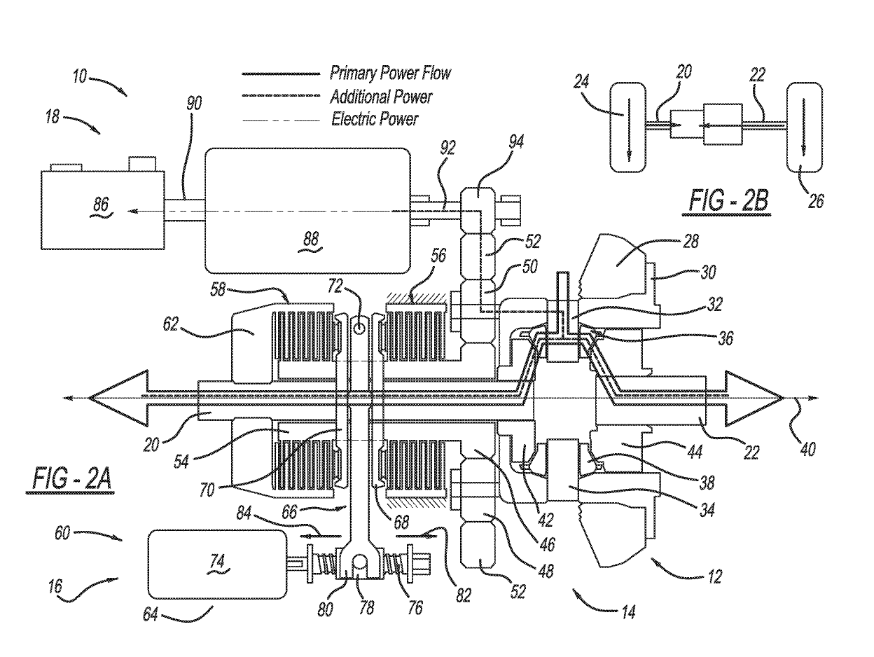

FIG. 2A shows the integrated electronic drive unit 10 operating in a braking mode. Power from the vehicle power source and rotational momentum can be directed through the differential 12 and the axles 20, 22 to the wheels 24, 26. The clutch pack 56 can be compressed and therefore the sun gear 46 can be fixed. The planet gears 48, 50 are carried by the cage 30 and can orbit the sun gear 46. The planet gears 48, 50 can also rotate about respective central axes. The planet gears 48, 50 can orbit the sun gear 46 in a first rotational direction. Since the sun gear 46 is fixed and the planet gears 48, 50 orbit in the first rotational direction, the ring gear 52 can also rotate about the axis 40 in the first rotational direction. The externally-directed teeth of the ring gear 52 can be meshed with the gear 94. Rotation of the ring gear 52 in the first rotational direction can cause rotation of the gear 94 in a second rotational direction. The gear 94, motor shaft 92, motor 88, battery 86, and electrical connection 90 can be arranged such that rotation of the gear 94 in the second rotational direction can result in the motor 88 operating as a generator and charging the battery 86.

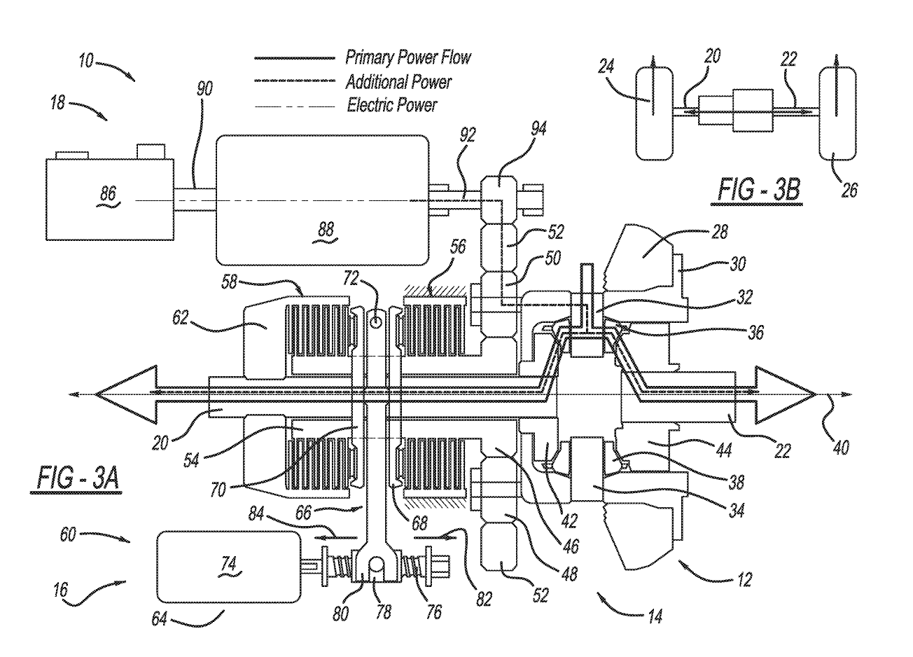

FIG. 3A shows the integrated electronic drive unit 10 operating in an electric vehicle start mode. Power from the vehicle power source can be directed through the differential 12 and the axles 20, 22 to the wheels 24, 26. Power from the secondary power system 16 can also be directed to the wheels 24, 26. The clutch pack 56 can be compressed and therefore the sun gear 46 can be fixed. The battery 86 can power the motor 88 to rotate the gear 94 in the second rotational direction. The ring gear 52 can be driven in rotation in the first rotational direction by rotation of the gear 94 in the second rotational direction. Since the sun gear 46 is fixed and the ring gear rotates in the first rotational direction, the planet gears 48, 50 can orbit the sun gear 46 in the first rotational direction. The planet gears 48, 50 are carried by the case 30. Thus, orbiting of the planet gears 48, 50 provide rotational power to the wheels 24, 26 through the differential 12 and the axles 20, 22.

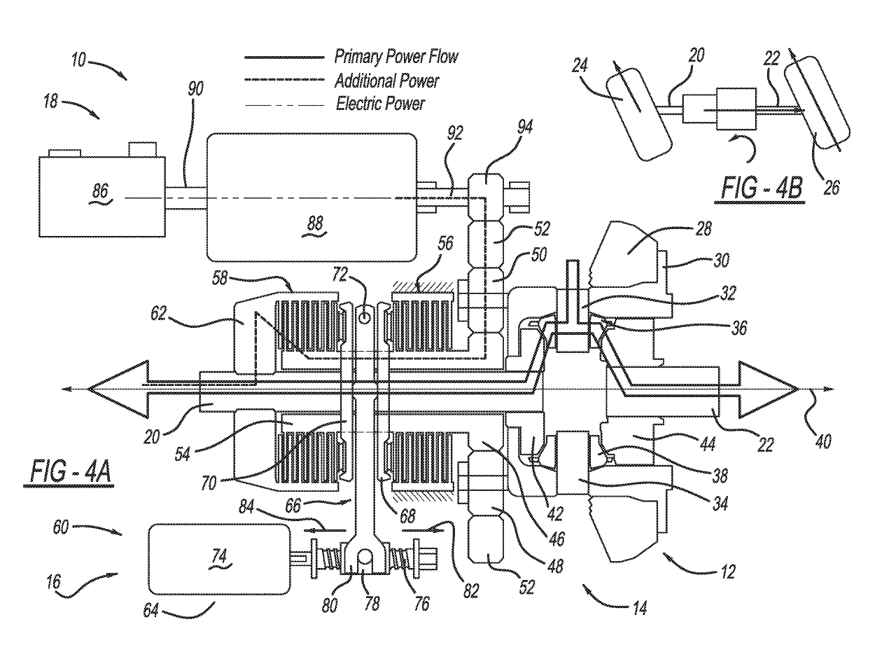

FIG. 4A shows the integrated electronic drive unit 10 operating in a torque vectoring, left-turn mode. In this mode, the integrated electronic drive unit 10 can generate drag on the wheel 24 through the axle 20 to extract energy from the axle 20 and store energy in the battery 86. This allows the wheel 26 to rotate faster than the wheel 24. The clutch pack 58 can be compressed to couple the axle 20 and the sleeve portion 54/sun gear 46. The planet gears 48, 50 are carried by the case 30. The case 30 and the axle 20 rotate in the same direction about the axis 40, the first rotational direction. Therefore, the sun gear 46 rotates and the planet gears 48, 50 orbit in the first rotational direction. Further, the ring gear 52 rotates about the axis 40 in the first rotational direction. The externally-directed teeth of the ring gear 52 can be meshed with the gear 94. Rotation of the ring gear 52 in the first rotational direction can cause rotation of the gear 94 in a second rotational direction. The gear 94, motor shaft 92, motor 88, battery 86, and electrical connection 90 can be arranged such that rotation of the gear 94 in the second rotational direction can result in the motor 88 operating as a generator and charging the battery 86.

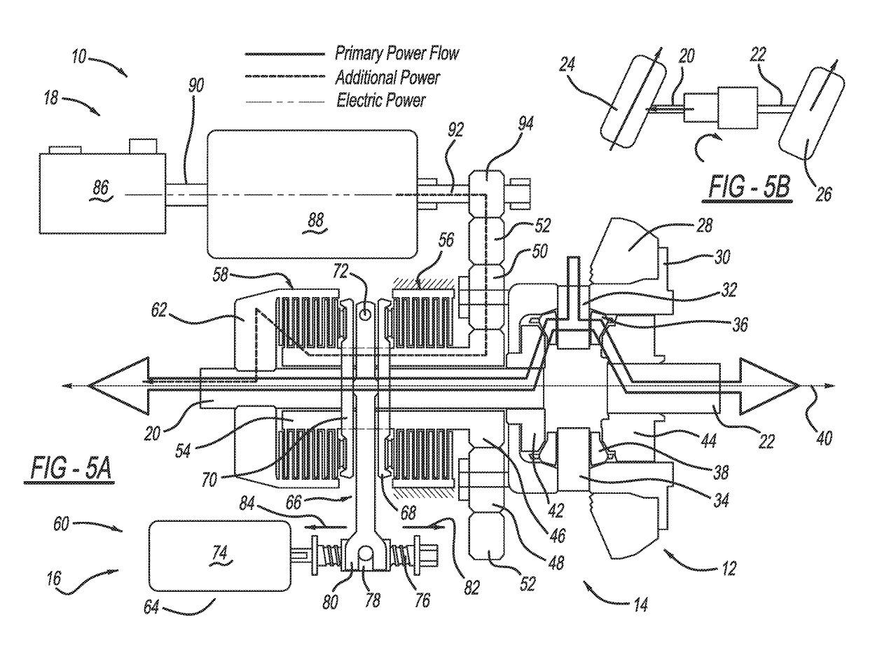

FIG. 5A shows the integrated electronic drive unit 10 operating in a torque vectoring, right-turn mode. In this mode, the integrated electronic drive unit 10 can deliver more torque to the wheel 24 through the axle 20. Power from the vehicle power source can be directed through the differential 12 and the axles 20, 22 to the wheels 24, 26. Power from the secondary power system 16 can also be directed to the wheel 24. The battery 86 can power the motor 88 to rotate the gear 94 in the second rotational direction. The ring gear 52 can be driven in rotation in the first rotational direction by rotation of the gear 94 in the second rotational direction.

The clutch pack 58 can be compressed to couple the axle 20 and the sleeve portion 54/sun gear 46. The planet gears 48, 50 are carried by the case 30. The case 30 and the axle 20 rotate in the same direction about the axis 40, the first rotational direction. Therefore, the sun gear 46 rotates and the planet gears 48, 50 orbit in the first rotational direction. Further, the ring gear 52 rotates about the axis 40 in the first rotational direction because the sun gear 46 rotates and the planet gears 48, 50 orbit in the first rotational direction. Since the motor 88 is driving the ring gear 52 through the gear 94, the secondary power system 16 is delivering power to the axle 20 through the planetary gear set.

The foregoing description of the examples has been provided for purposes of illustration and description. It is not intended to be exhaustive or to limit the disclosure. Individual elements or features of a particular example are generally not limited to that particular example, but, where applicable, are interchangeable and can be used in a selected example, even if not specifically shown or described. The same may also be varied in many ways. Such variations are not to be regarded as a departure from the disclosure, and all such modifications are intended to be included within the scope of the disclosure.

What is claimed is:

1. An integrated electronic drive unit comprising:
a differential having a ring gear fixed for concurrent rotation with a differential case, the differential having a plurality of pinion gears rotatably mounted to the differential case and meshed with first and second side gears;
a first axle coupled to the first side gear;
a second axle coupled to the second side gear; and
a secondary power system selectively engageable to at least one of the first and second axles;
wherein the integrated electronic drive unit is operable in (i) an open differential mode wherein vehicle power is directed through the differential and the first and second axles, (ii) a braking mode wherein vehicle power is directed toward the secondary power system, (iii) an electric vehicle start mode wherein vehicle power is directed through the differential to the first and second axles and the secondary power system is also directed to one of the first and second axles; and (iv) a torque vectoring mode.

2. The integrated electronic drive unit of claim 1 further comprising:
a gear train that couples the differential and the secondary power system.

3. The integrated electronic drive unit of claim 2 wherein the gear train comprises a planetary gear set having a sun gear, a first and a second planet gears, and a planetary ring gear, wherein the sun gear encircles the first axle.

4. The integrated electronic drive unit of claim 3 wherein the sun gear includes a sleeve portion that extends away from the differential.

5. The integrated electronic drive unit of claim 4 wherein the differential case is a carrier of the first and second planet gears.

6. The integrated electronic drive unit of claim 5 wherein the planetary ring gear is meshed with at least one of the first and second planet gears.

7. The integrated electronic drive unit of claim 2 further comprising:
a dual-directional clutch having a first clutch pack positioned to selectively prevent rotation of the sun gear.

8. The integrated electronic drive unit of claim 3 wherein the dual-directional clutch further comprises:
a second clutch pack positioned between the sleeve portion of the sun gear and a clutch basket.

9. The internal electronic drive unit of claim 8 wherein the clutch basket is fixed for rotation with the first axle and wherein when the second clutch pack is compressed, the sun gear is locked to the first axle for concurrent rotation.

10. The integrated electronic drive unit of claim 9, further comprising:
an actuator comprising:
a lever arm;
a first thrust plate;
a second thrust plate; and
a ball screw configured to move the lever arm in one of a first direction and a second direction, wherein the first clutch pack is compressed upon movement in the first direction and the second clutch pack is compressed upon movement in the second direction.

13. The integrated electronic drive unit of claim 12 wherein the lever arm is pivotally moveable.

14. The integrated electronic drive unit of claim 1 wherein the secondary power system comprises a battery and a motor, wherein in the torque vectoring mode the integrated electronic drive unit generates drag on one wheel through one of the first and second axles and extracts energy to store in the battery.

15. An integrated electronic drive unit comprising:
a differential having a plurality of pinion gears rotatably mounted to the differential case and meshed with first and second side gears;
a first axle associated with a first wheel and coupled to the first side gear;
a second axle associated with a second wheel and coupled to the second side gear; and
a secondary power system having a battery and an electric motor, the electric motor being selectively engageable to at least one of the first and second axles;
wherein the integrated electronic drive unit is operable in (i) an open differential mode wherein vehicle power is directed through the differential and the first and second axles, (ii) a braking mode wherein vehicle power is directed toward the electric motor, and (iii) an electric vehicle start mode wherein total vehicle power is directed to the first and second axles from both of the differential and the electric motor.

16. The integrated electronic drive unit of claim 15 wherein the integrated electronic drive unit is further operable in a (iv) torque vectoring mode, wherein in the torque vectoring mode the integrated electronic drive unit generates drag on one of the first and second wheels through one of the first and second axles and extracts energy to store in the battery.

17. The integrated electronic drive unit of claim 16 further comprising:
a planetary gear set having a sun gear, a first and a second planet gears, and a planetary ring gear, wherein the planetary gear set couples the differential and the electric motor and wherein the sun gear encircles the first axle and includes a sleeve portion that extends away from the differential.

18. The integrated electronic drive unit of claim 17 wherein the differential case is a carrier of the first and second planet gears and wherein the planetary ring gear is meshed with at least one of the first and second planet gears.

19. The integrated electronic drive unit of claim 18, further comprising: a dual-directional clutch having a first clutch pack positioned to selectively prevent rotation of the sun gear and a second clutch pack positioned between the sleeve portion of the sun gear and a clutch basket, wherein the clutch basket is fixed for rotation with the first axle and wherein when the second clutch pack is compressed, the sun gear is locked to the first axle for concurrent rotation.

20. The integrated electronic drive unit of claim 19, further comprising:
an actuator comprising:
a lever arm;
a first thrust plate;
a second thrust plate; and
a ball screw configured to move the lever arm in one of a first direction and a second direction, wherein the first clutch pack is compressed upon movement in the first direction and the second clutch pack is compressed upon movement in the second direction.
